(19) United States
(12) Patent Application Publication
(10) Pub. No.: US 2013/0245205 A1
(43) Pub. Date: Sep. 19, 2013

(54) METHOD FOR PRODUCING POLYBUTYLENE TEREPHTHALATE BASED RESIN COMPOSITION, AND POLYBUTYLENE TEREPHTHALATE-BASED RESIN COMPOSITION FOR MOLDING

(71) Applicant: Shinya Yamada, Shizuoka (JP)

(72) Inventor: Shinya Yamada, Shizuoka (JP)

(73) Assignee: Win Tech Polymer Ltd., Tokyo (JP)

(21) Appl. No.: 13/989,445

(22) PCT Filed: Nov. 21, 2011
(86) PCT No.: PCT/JP2011/076795

§ 371 Date: May 24, 2013

(30) Foreign Application Priority Data
Nov. 29, 2010 (JP) 2010-264585

(51) Int. Cl. C08G 63/46

(52) U.S. Cl. CPC C08G 63/46
USPC 525/437

(57) ABSTRACT

Provided are: a method for producing a polybutylene terephthalate-based resin composition which is capable of providing a molded article obtained therefrom with excellent physical properties such as excellent mechanical strength, while stably maintaining high fluidity when melted; and a polybutylene terephthalate-based resin composition for molding. Specifically, after melting a mixture that contains (A) a polybutylene terephthalate resin and (B) a polyvalent hydroxyl group-containing compound, (C) a phosphorus compound is added thereto. It is preferable to use a glycerin fatty acid ester or an ether obtained by an addition reaction of an alkylene oxide to a diglycerin as (B) a polyvalent hydroxyl group-containing compound.

### TECHNICAL FIELD

The present invention relates to a method for producing a polybutylene terephthalate-based resin composition, and a polybutylene terephthalate-based resin composition for molding.

### BACKGROUND ART

A polybutylene terephthalate resin is widely used as an engineering plastic in various applications such as automobile parts and electric/electronic parts because of having excellent mechanical properties, electrical properties, heat resistance, weatherability, water resistance, chemical resistance and solvent resistance.

The polybutylene terephthalate resin is useful as mentioned above. However, it may often become difficult to produce a thin-wall plate- or box-shaped molded article because of a problem of fluidity when melted. Herein, the thin-wall molded article includes, for example, a micro-switch case, a small coil bobbin, a thin-wall connector, and a disk cartridge shutter. In particular, the above problem of fluidity of the polybutylene terephthalate resin remarkably occurs in a polybutylene terephthalate-based resin composition having physical properties improved by mixing with an inorganic filler.

A study is now made so as to improve fluidity of a polybutylene terephthalate-based resin composition when melted in view of a material. For example, Patent Document 1 discloses a polybutylene terephthalate-based resin composition blended with polybutylene terephthalate-based resins each having a different viscosity (number of average molecular weight) at a predetermined ratio. Patent Document 1 discloses that the resin composition in Patent Document 1 enables an improvement in cyclic fatigue resistance of a molded article obtained by molding the resin composition, and also has high fluidity in a molten state. However, when using the resin composition in Patent Document 1 as a raw material, the obtained molded article is inferior in physical properties such as elongation of the resin as compared with the case where a high-viscosity polybutylene terephthalate resin-based is used alone as a raw material.

It is also known that a fluidity improver is added to a polybutylene terephthalate resin so as to improve fluidity of the resin on molding. For example, Patent Document 2 discloses a polybutylene terephthalate-based resin composition which serves as a raw material of a molded article with excellent mechanical properties, and is also excellent in fluidity when melted.

Patent Document 1: Japanese Unexamined Patent Application, Publication No. H05-179114

Patent Document 2: Japanese Unexamined Patent Application, Publication No. 2009-138179

### DISCLOSURE OF THE INVENTION

### Problems to be Solved by the Invention

The polybutylene terephthalate-based resin composition disclosed in Patent Document 2 is suited as a raw material for producing a thin-wall molded article because of excellent fluidity when melted. Despite the fact that the polybutylene terephthalate-based resin composition disclosed in Patent Document 2 is excellent, progress has been made in the research and development so as to obtain a more excellent resin composition.

The present invention has been made so as to solve the above problems and an object thereof is to provide a method for producing a polybutylene terephthalate-based resin composition which is capable of providing a molded article obtained therefrom with excellent physical properties such as excellent mechanical strength, while stably maintaining high fluidity when melted; and a polybutylene terephthalate-based resin composition for molding.

### Means for Solving the Problems

The present inventors have intensively studied so as to achieve the above object. As a result, they have found that the resin composition containing a polybutylene terephthalate resin and a glycerin fatty acid ester in Patent Document 2 has high fluidity when melted due to transesterification between the polybutylene terephthalate resin and the glycerin fatty acid ester. They have also found that the above object can be achieved by adding a phosphorus compound on or after melt-kneading of a mixture containing a polybutylene terephthalate resin and a polyvalent hydroxyl group-containing compound, and thus completing the present invention. More specifically, the present invention provides the followings.

(1) A method for producing a polybutylene terephthalate-based resin composition, which comprises melting a mixture containing (A) a polybutylene terephthalate resin and (B) a polyvalent hydroxyl group-containing compound, and then adding (C) a phosphorus compound.

(2) The method for producing a polybutylene terephthalate-based resin composition according to (1), wherein the polybutylene terephthalate-based resin composition exhibits a value of a melt viscosity of 120 Pa·s or less, measured at a temperature of 260° C. under a shear rate of 1,000 sec⁻¹ in accordance with ISO11443.

(3) The method for producing a polybutylene terephthalate-based resin composition according to (1) or (2), wherein the polybutylene terephthalate-based resin composition satisfies the following numerical expression (I):

Peak temperature Tₘ₁ (° C.)−peak temperature Tₘ₄ (° C.)≦1 (° C.) (I)

where a peak temperature Tₘ₁ (° C.) in the numerical expression (I) represents a peak temperature of a maximum endothermic peak of a DSC curve in differential scanning calorimetry (DSC) in temperature rising on the 1st cycle when performing 4 cycles, each cycle comprising raising the temperature of the polybutylene terephthalate-based resin composition from 50° C. to 280° C. at a temperature rising rate of 10° C./minute, and dropping the temperature from 280° C. to 50° C. at a temperature falling rate of 10° C./minute, and a peak temperature Tₘ₄ (° C.) in the numerical expression (I) represents a peak temperature of a maximum endothermic peak of a DSC curve in differential scanning calorimetry (DSC) in temperature rising on the 4th cycle.

(4) The method for producing a polybutylene terephthalate-based resin composition according to any one of (1) to (3), wherein the mixture further comprises (D) a transesterification catalyst and (D) the transesterification catalyst is added before the addition of (C) the phosphorus compound.

(5) The method for producing a polybutylene terephthalate-based resin composition according to any one of (1) to (4), wherein (B) the polyvalent hydroxyl group-containing compound is a glycerin fatty acid ester or an ether obtained by an addition reaction of an alkylene oxide to a diglycerin.

(6) A polybutylene terephthalate-based resin composition for molding, comprising (A) a polybutylene terephthalate-based resin, (B) a polyvalent hydroxyl group-containing compound, (C) a phosphorus compound and (D) a transesterification catalyst, wherein a value of melt viscosity, measured at a temperature of 260° C. under a shear rate of 1,000 sec⁻¹ in accordance with ISO11443, is 120 Pa·s or less.

### Effects of the Invention

According to the present invention, it is possible to obtain a polybutylene terephthalate-based resin composition which is capable of providing the obtained molded article with excellent physical properties such as excellent mechanical strength, etc, while stably maintaining high melt fluidity.

### PREFERRED MODE FOR CARRYING OUT THE INVENTION

Embodiments of the present invention will be described in detail below. The present invention is not limited to the following embodiments.

In the method for producing a polybutylene terephthalate-based resin composition of the present invention, a mixture containing (A) a polybutylene terephthalate resin and (B) a polyvalent hydroxyl group-containing compound is melted, and then (C) a phosphorus compound is added. First, a summary of the present invention will be described.

Melting of a mixture containing (A) a polybutylene terephthalate resin and (B) a polyvalent hydroxyl group-containing compound causes transesterification between (A) a polybutylene terephthalate resin and (B) a polyvalent hydroxyl group-containing compound. This transesterification causes an improvement in fluidity of a polybutylene terephthalate-based resin composition when melted.

Unless transesterification between (A) a polybutylene terephthalate resin and (B) a polyvalent hydroxyl group-containing compound is stopped in the middle, the degree of melt fluidity may sometimes vary depending on the time during which a resin composition is in a molten state until the resin composition is molded to form a molded article. Excessive progress of transesterification may sometimes lead to decomposition of the polybutylene terephthalate resin. Decomposition of the polybutylene terephthalate resin may sometimes lead to deterioration of physical properties of the obtained molded article.

Thus, in the production method of the present invention, a mixture containing (A) a polybutylene terephthalate resin and (B) a polyvalent hydroxyl group-containing compound is melted, and then (C) a phosphorus compound is added, thereby stopping transesterification between (A) a polybutylene terephthalate resin and (B) a polyvalent hydroxyl group-containing compound. Thereby, it is possible to stabilize the degree of melt fluidity of the polybutylene terephthalate-based resin composition, and to significantly reduce the possibility of deterioration of physical properties of the molded article due to excessive progress of transesterification.

Description will be made on materials such as a mixture containing (A) a polybutylene terephthalate resin and (B) a polyvalent hydroxyl group-containing compound, and (C) a phosphorus compound which are used in the production method of the present invention.

### Mixture

A mixture contains (A) a polybutylene terephthalate resin and (B) a polyvalent hydroxyl group-containing compound. The mixture may further contain other components.

### (A) Polybutylene Terephthalate Resin

(A) A polybutylene terephthalate resin is a thermoplastic resin which contains at least a terephthalic acid (terephthalic acid or an ester-forming derivative thereof), and an alkylene glycol having 4 carbon atoms (1,4-butanediol) or an ester-forming derivative thereof, as polymerization component.

Examples of (A) the polybutylene terephthalate resin (PBT resin), as a base resin, include a homopolyester containing butylene terephthalate as a main component (polybutylene terephthalate) or a copolyester (butylene terephthalate-based copolymer or polybutylene terephthalate copolyester), etc. As used herein, “main component” means that the content of a component of butylene terephthalate in the resin is, for example, 50% by mass or more (for example, 55% by mass or more and 100% by mass or less), preferably 60% by mass or more (for example, 65% by mass or more and 100% by mass or less), and more preferably 70% by mass or more (for example, 75% by mass or more and 100% by mass or less).

Examples of the copolymerizable monomer in a copolyester (butylene terephthalate-based copolymer or modified PBT resin) (hereinafter sometimes referred to simply as a copolymerizable monomer) include a dicarboxylic acid component excluding terephthalic acid, a diol excluding 1,4-butanediol, an oxycarboxylic acid component, and a lactone component, etc. Copolymerizable monomers can be used alone, or in combination of two or more of copolymerizable monomers. Specific examples of the copolymerizable monomer include copolymerizable monomers similar to those disclosed in Japanese Unexamined Patent Application, Publication No. 2009-138179. Examples of preferable copolymerizable monomer also include copolymerizable monomers similar to those disclosed in Japanese Unexamined Patent Application, Publication No. 2009-138179.

(A) The polybutylene terephthalate resin is preferably a homopolyester (polybutylene terephthalate) and/or a copolymer (polybutylene terephthalate copolyester). (A) The polybutylene terephthalate resin may be a homo- or copolyester (particularly homopolyester) in which the ratio of the copolymerizable monomer (amount of modification) is usually 45 mol % or less (for example, about 0 mol % or more and 45 mol % or less), preferably 35 mol % or less (for example, about 0 mol % or more and 35 mol % or less), and more preferably 30 mol % or less (for example, about 0 mol % or more and 30 mol % or less).

In the copolymer, the ratio of the copolymerizable monomer can be selected, for example, from a range of about 0.01 mol % or more and 30 mol % or less, usually about 1 mol % or more and 30 mol % or less, preferably about 3 mol % or more and 25 mol % or less, and more preferably about 5 mol % or more and 20 mol % or less. When the homopolyester (polybutylene terephthalate) is used in combination with the copolymer (copolyester), the ratio of the homopolyester to the copolyester, that is, the ratio of the copolymerizable monomer to the whole monomer is within a range of 0.1 mol % or more and 30 mol % or less (preferably about 1 mol % or more and 25 mol % or less, and more preferably about 5 mol % or more and 25 mol % or less). Usually, the ratio former/latter can be selected from a range from about 99/1 to 1/99 (mass ratio), preferably from about 95/5 to 5/95 (mass ratio), and more preferably from about 90/10 to 10/90 (mass ratio).

(A) The polybutylene terephthalate resin preferably has an intrinsic viscosity (IV) of 1.0 dL/g or less, and more preferably 0.9 dL/g or less. By blending (A) polybutylene terephthalate resins, each having a different intrinsic viscosity, for example, blending a polybutylene terephthalate resin having an intrinsic viscosity of 1.2 dL/g with a polybutylene terephthalate resin having an intrinsic viscosity of 0.8 dL/g, an intrinsic viscosity of 1.0 dL/g or less may be realized. The intrinsic viscosity (IV) can be measured, for example, in o-chlorophenol under the condition of a temperature of 35° C. Use of a polybutylene terephthalate resin having an intrinsic viscosity within the above range makes it easier to impart sufficient toughness and to decrease a melt viscosity. Too large intrinsic viscosity causes an increase in melt viscosity on molding, and may sometimes cause poor fluidity or poor filling in a mold.

It is possible to use, as (A) the polybutylene terephthalate resin, commercially available products, and those produced by copolymerization (polycondensation) of terephthalic acid or a reactive derivative thereof, 1,4-butanediol and, if necessary, a copolymerizable monomer using a common method, for example, transesterification or direct esterification.

### (B) Polyvalent Hydroxyl Group-Containing Compound

(B) A polyvalent hydroxyl group-containing compound is a compound having 2 or more hydroxyl groups in a molecule. (B) The polyvalent hydroxyl group-containing compound serves as a fluidity improver. Usually, the addition of the fluidity improver to (A) the polybutylene terephthalate resin enables an improvement in fluidity, but makes it impossible to avoid deterioration of mechanical strength of (A) the polybutylene terephthalate resin per se, and properties such as toughness. However, use of a polyvalent hydroxyl group-containing compound efficiently enables an improvement in fluidity of a polybutylene terephthalate-based resin composition when melted while maintaining properties of (A) a polybutylene terephthalate resin in a high level.

(B) The polyvalent hydroxyl group-containing compound to be used may be either those produced by a conventionally know method or commercially available products purchased.

(B) The polyvalent hydroxyl group-containing compound preferably has a hydroxyl value of 200 or more, and more preferably 250 or more. The hydroxyl value of 200 or more is preferable since the fluidity improving effect tends to increase.

The content of (B) the polyvalent hydroxyl group-containing compound is preferably 0.05 part by mass or more and 5 parts by mass or less, based on 100 parts by mass of (A) the polybutylene terephthalate resin. The content is more preferably 0.5 part by mass or more and 3 parts by mass or less. The content of the polyvalent hydroxyl group-containing compound of 0.05 part by mass or more is preferable since the fluidity improving effect tends to be sufficiently obtained. The content of 5 parts by mass or less scarcely causes poor appearance of a molded article or mold staining caused by increase in amount of a gas generated by molding.

From the viewpoint of providing a polybutylene terephthalate-based resin composition with fluidity when melted, and providing the obtained molded article while scarcely causing physical properties of (A) the polybutylene terephthalate resin to deteriorate, it is preferred to use, as (B) the polyvalent hydroxyl group-containing compound, a glycerin fatty acid ester or an ether obtained by an addition reaction of an alkylene oxide to a diglycerin. Specific examples of the glycerin fatty acid ester, and the ether obtained by an addition reaction of an alkylene oxide to diglycerin will be shown below in this order.

First, the glycerin fatty acid ester will be described. The glycerin fatty acid ester is an ester composed of a glycerin and/or a dehydrated condensate thereof and fatty acid. Among glycerin fatty acid esters, those obtained by using fatty acid having 12 or more carbon atoms is preferable. Examples of the fatty acid having 12 or more carbon atoms include lauric acid, oleic acid, palmitic acid, stearic acid, 12-hydroxystearic acid, behenic acid and montanoic acid, etc. The fatty acid is preferably fatty acid having 12 or more and 32 or less carbon atoms, and particularly preferably fatty acid having 12 or more and 22 or less carbon atoms. Specifically, lauric acid, stearic acid, 12-hydroxystearic acid or behenic acid is particularly preferable. Use of fatty acid having 12 or more carbon atoms is preferable since it tends to be possible to sufficiently maintain heat resistance of the resin. Use of fatty acid having 32 or less carbon atoms is preferable since high fluidity improving effect is exerted.

Examples of preferable glycerin fatty acid ester include glycerin monostearate, glycerin monobehenate, diglycerin monostearate, triglycerin monostearate, a partial ester of triglycerin and stearic acid, a partial ester of tetraglycerin and stearic acid, a partial ester of decaglycerin and lauric acid, and glycerin mono-12-hydroxystearate.

The ether obtained by an addition reaction of an alkylene oxide to a diglycerin will be described below. Examples thereof include polyoxypropylene diglyceryl ether obtained by an addition reaction of a propylene oxide to a diglycerin, and polyoxyethylene diglyceryl ether obtained by an addition reaction of an ethylene oxide to a diglycerin. In the present invention, among these ethers, polyoxyethylene diglyceryl ether is used particularly preferably.

### Other Components

The mixture can contain other resins, and conventionally known additives such as antioxidants, pigments and plasticizer unless the addition of these resins and additives adversely affects the features or effects of the present invention. In the present invention, it may be sometimes preferable for the mixture to contain (D) a transesterification catalyst and inorganic filler as other components. Thus, (D) the transesterification catalyst and the inorganic filler will be described below in this order.

When the mixture contains (D) the transesterification catalyst, transesterification between (A) the polybutylene terephthalate resin and (B) the polyvalent hydroxyl group-containing compound is accelerated. When it requires long time to reach a desired fluidity because of slow transesterification between (A) the polybutylene terephthalate resin and (B) the polyvalent hydroxyl group-containing compound, use of (D) a transesterification catalyst enables quick realization of the desired fluidity.

There is no particular limitation on (D) the transesterification catalyst and, for example, metal compounds can be used as (D) the transesterification catalyst. Among these metal compounds, titanium compounds, tin compounds and antimony compounds are preferably used. Specific examples of the titanium compounds are typically inorganic titanium compounds such as titanium oxide; titanium alcoholates such as tetramethyl titanate, tetraisopropyl titanate and tetrabutyl titanate; and titanium phenolates such as tetraphenyl titanate. Specific examples of the tin compounds include dibutyltin oxide, hexaethylditin oxide, didodecyltin oxide, triethyltin hydroxide, tributyltin acetate, dibutyltin diacetate, diphenyltin dilaurate, monobutyltin trichloride, methylstannoic acid, ethylstannoic acid and butylstannoic acid. Specific examples of the antimony compounds include antimony trioxide, etc. Among these compounds, tetrabutyl titanate, tributyltin acetate and antimony trioxide are used particularly preferably.

It is preferred that type and amount of (D) the transesterification catalyst are appropriately adjusted according to type of compounds contained in the mixture. The use amount of (D) the transesterification catalyst is, for example, 0.001 part by mass or more and 0.1 part by mass or less, based on 100 parts by mass of (A) the polybutylene terephthalate resin.

The inorganic filler will be described below. When the mixture contains an inorganic filler, it is possible to further enhance physical properties such as mechanical strength of the obtained molded article. Any of a fibrous filler, a particulate filler and a plate-like filler can be used as the inorganic filler. Examples of the fibrous filler include a glass fiber, an asbestos fiber, a silica fiber, a silica/alumina fiber, an alumina fiber, a zirconia fiber, a boron nitride fiber, a silicon nitride fiber, a boron fiber and a potassium titanate fiber, as well as inorganic fibrous materials, for example, fibrous materials of metals such as stainless steel, aluminum, titanium, copper and brass. Examples of the particulate filler include silicates such as silica, quartz powder, glass beads, milled glass fiber, glass balloon, glass powder, calcium silicate, aluminum silicate, kaolin, talc, clay, diatomaceous earth and wollastonite; oxides of metals, such as iron oxide, titanium oxide, zinc oxide, antimony trioxide and alumina; carbonates of metals, such as calcium carbonate and magnesium carbonate; sulfates of metals, such as calcium sulfate and barium sulfate; and ferrite, silicon carbide, silicon nitride, boron nitride, and various metal powders, etc. Examples of the plate-like filler include mica, glass flake, and various metal foils.

It is preferred that type and amount of the inorganic filler are appropriately adjusted according to type of compounds contained in the mixture. The use amount of the inorganic filler is, for example, 10 parts by mass or more and 50 parts by mass or less, based on 100 parts by mass of (A) the polybutylene terephthalate resin.

### (C) Phosphorus Compound

(C) A phosphorus compound is used so as to stop transesterification between (A) a polybutylene terephthalate resin and (B) a polyvalent hydroxyl group-containing compound.

When the mixture is melted, transesterification continuously proceeds. Therefore, fluidity of the mixture is improved when compared with the case of using no (B) polyvalent hydroxyl group-containing compound. When transesterification excessively proceeds, physical properties of the obtained molded article may deteriorate. However, as mentioned above, transesterification is stopped by (C) the phosphorus compound in the present invention, thus a problem such as deterioration of physical properties does not occur. It is possible to stabilize the melt fluidity to the desired degree of fluidity by adjusting timing of the addition of (C) the phosphorus compound.

Examples of usable (C) phosphorus compound include, but are not limited to, phosphine-based, phosphinite-based, phosphonite-based, phosphite-based, phosphinous amide-based, phosphonous diamide-based, phosphorus triamide-based, phosphoramidite-based, phosphorodiamidite-based, phosphine oxide-based, phosphinate-based, phosphonate-based, phosphate-based, phosphinic amide-based, phosphonodiamidate-based, phosphoramide-based, phosphoramidate-based, phosphorodiamidate-based, phosphineimide-based and phosphine sulfide-based phosphorus compounds. The phosphorus compound includes those which form salts with metals.

There is no particular limitation on type and use amount of (C) the phosphorus compound, and they can be appropriately adjusted according to the conditions such as type of compounds contained in the mixture. For example, the use amount of (C) the phosphorus compound is 0.01 part by mass or more and 0.8 part by mass or less, and preferably 0.05 part by mass or more and 0.5 part by mass or less, based on 100 parts by mass of (A) the polybutylene terephthalate resin.

### Production Method

The production method of the present invention will be described below. In the production method of the present invention, a mixture containing (A) a polybutylene terephthalate resin and (B) a polyvalent hydroxyl group-containing compound is melted, and then (C) a phosphorus compound is added. The production method of the present invention can be carried out using a conventionally known extruder. The production method of the present invention will be described below by way of example, with reference to the case of carrying out the production method of the present invention using a common extruder. In this example, the obtained resin composition is a molded article.

First, a common extruder will be briefly described. The extruder is provided with a screw, and a raw material is charged from a hopper provided at the corresponding position in the vicinity of the root of the screw. The raw material thus charged is transferred to the tip from the root of the screw by rotation of the screw. The raw material transferred to the tip of the screw is molded by passing through a die provided at the tip of the extruder from the tip of the screw.

The screw used in the common extruder includes, from upstream toward downstream of the screw, a feed zone, a compression zone and a metering zone in this order from the hopper side. The feed zone has the function of transferring resin pellets to the die direction side from the hopper side at a temperature set so as not to cause melting of the raw material, and transfers the raw material to the compression zone. The compression zone allows the raw material to undergo melt-kneading while applying a pressure to the raw material, and transfers the melt-kneaded raw material to the metering zone. The metering zone pumps out the molten raw material in a given amount to a die under a given pressure.

The production method of the present invention will be specifically described below.

(A) A polybutylene terephthalate resin and (B) a polyvalent hydroxyl group-containing compound, serving as raw materials, are charged in an extruder from a hopper. (A) The polybutylene terephthalate resin and (B) the polyvalent hydroxyl group-containing compound charged from the hopper are transferred to the compression zone from the feed zone while being mixed.

The mixture of (A) the polybutylene terephthalate resin and (B) the polyvalent hydroxyl group-containing compound transferred to the compression zone is transferred to the metering zone while being melt-kneaded in the compression zone. Melt-kneading enables proceeding of transesterification between (A) the polybutylene terephthalate resin and (B) the polyvalent hydroxyl group-containing compound. Transesterification proceeds, and thus improving fluidity of the obtained molded article when melted. Therefore, the addition of (C) a phosphorus compound during melt-kneading in the compression zone makes it possible to stop the transesterification after improving the fluidity. (C) The phosphorus compound may be added in the below-mentioned metering zone if it is not added in the compression zone (the addition in the metering zone corresponds to the addition after melt-kneading).

The mixture transferred to the metering zone is transferred to a die in a given amount under a given pressure in the metering zone. The mixture passed through the die is cooled to form a molded article. Also in the metering zone, the mixture is in a molten state and, if (C) the phosphorus compound is not added in the compression zone, transesterification continuously proceeds also in the metering zone. In order to stop the transesterification in the metering zone, (C) the phosphorus compound may be added in the metering zone. In order to sufficiently increase the fluidity of the obtained molded article when melted, (C) the phosphorus compound is preferably added after the metering zone.

While a description was made on the case of adding (C) the phosphorus compound by single melt-kneading in the above description, melt-kneading may be performed twice. For example, after obtaining pellets containing (A) a polybutylene terephthalate resin and (B) a polyvalent hydroxyl group-containing compound in a first melt-kneading, and charging the pellets again in an extruder, (C) a phosphorus compound may be added in any one position of the feed zone, the compression zone and the metering zone.

While a description was made on the case of no addition of other components mentioned above in the above description, other components may be added in any one position of the feed zone, the compression zone and the metering zone. Provided that it is necessary to add (D) a transesterification catalyst before the addition of (C) the phosphorus compound. The addition of (D) the transesterification catalyst may make it possible to sufficiently increase the fluidity of the obtained molded article when melted by single melt-kneading.

An inorganic filler may be added at any position. However, a fibrous inorganic filler in particular may be sometimes added after melting of a resin component so as to reduce fracture of fibers as much as possible when kneaded. In that case, the inorganic filler may be added alone, or added together with a phosphorus compound. It is possible to maintain high mechanical strength by reducing fracture of fibers.

### Resin Composition

Finally, a resin composition obtained by the production method of the present invention will be described. The resin composition of the present invention is excellent in fluidity when melted since the above transesterification is performed when molded. Specifically, for example, a value of a melt viscosity, measured at a temperature of 260° C. under a shear rate of 1,000 sec⁻¹ in accordance with ISO11443, is 120 Pa·s or less.

The production method of the present invention is repeatedly carried out while varying timing of the addition of (C) a phosphorus compound, and melt viscosities of all of the obtained resin compositions are confirmed, thereby making it possible to optimize timing of the addition of (C) the phosphorus compound. In the case of optimization of timing, amount and timing of addition of (D) the transesterification catalyst may also be studied.

In the above resin composition, transesterification is stopped by inclusion of (C) the phosphorus compound. Therefore, excessive progress of transesterification is less likely to cause deterioration of physical properties of the resin composition. Stopping of transesterification can be confirmed by differential scanning calorimetry (DSC). Specifically, it is possible to confirm by confirming the establishment of the numerical expression:

Peak temperature Tₘ₁ (° C.)−peak temperature Tₘ₄ (° C.)≦1 (° C.)

where a peak temperature Tₘ₁ (° C.) represents a peak temperature of a maximum endothermic peak of a DSC curve in differential scanning calorimetry (DSC) in temperature rising on the 1st cycle when performing 4 cycles, each cycle comprising raising the temperature of the polybutylene terephthalate-based resin composition from 50° C. to 280° C. at a temperature rising rate of 10° C./minute, and dropping the temperature from 280° C. to 50° C. at a temperature falling rate of 10° C./minute, and a peak temperature Tₘ₄ (° C.) represents a peak temperature of a maximum endothermic peak of a DSC curve in differential scanning calorimetry (DSC) in temperature rising on the 4th cycle. DSC is measured with reference to the method defined in JIS K7121.

### EXAMPLES

### Materials

(A) Polybutylene terephthalate resin: Polybutylene terephthalate resin (having an intrinsic viscosity IV of 0.69 dL/g, manufactured by WinTech Polymer Ltd.)

(B) Polyvalent hydroxyl group-containing compound

B-1: Partial ester of triglycerin and stearic acid (“RIKEMAL AF-70” having a hydroxyl value of 280, manufactured by RIKEN VITAMIN CO., LTD.)

B-2: Polyoxyethylene diglyceryl ether (“SCE-350” having a hydroxyl value of 630, manufactured by SAKAMOTO YAKUHIN KOGYO CO., LTD.)

(C) Phosphorus compound

C-1: Phosphite-based phosphorus compound (“Adekastab PEP-36”, manufactured by ADEKA CORPORATION)

C-2: Monocalcium phosphate (manufactured by Taihei Chemical Industrial Co., Ltd.)

(D) Transesterification catalyst

D-1: Tetra-n-butyl titanate

D-2: Antimony trioxide (“PATOX-U”, manufactured by NIHON SEIKO CO. LTD.)

D-3: Tributyltin acetate

In the whole compositions of Examples and Comparative Examples, 40 parts by mass of a glass fiber and 0.3 part by mass of a hindered phenol-based antioxidant IRGANOX1010 (manufactured by Ciba Specialty Chemicals Corporation) were added to 100 parts by weight of (A) a polybutylene terephthalate resin.

A hydroxyl value of (B) a polyvalent hydroxyl group-containing compound was measured by the Yukagaku Kyokai method: 2,4,9,2-71 hydroxyl value (pyridine/acetic anhydride method).

### Examples 1 to 3

According to the formulation shown in Table 1, (A) a polybutylene terephthalate resin, (B) a polyvalent hydroxyl group-containing compound, (C) a phosphorus compound, (D) a transesterification catalyst, and the above-mentioned glass fiber and antioxidant were used. First, materials other than (C) the phosphorus compound and the glass fiber were charged in a twin screw extruder, and then the mixture was melt-kneaded at a cylinder temperature of 260° C., a screw speed of 130 rpm and an extrusion rate of 12 kg/hour. (C) The phosphorus compound and the glass fiber were charged from the rear portion of the extruder, which is presumed to undergo sufficient melt-kneading, thus leading to the progress of transesterification. The strand-shaped molten resin ejected from a twin screw extruder was cooled and then cut by a pelletizer to obtain a pellet-shaped sample of a resin composition.

### Examples 4 and 6

According to the formulation shown in Table 1, (A) a polybutylene terephthalate resin, (B) a polyvalent hydroxyl group-containing compound and the above-mentioned antioxidant were charged in a twin screw extruder and then mixed. The mixture was melt-kneaded at a cylinder temperature of 260° C., a screw speed of 130 rpm and an extrusion rate of 10 kg/hour, and then the ejected strand-shaped molten resin was cooled and then cut by a pelletizer to obtain a pellet-shaped sample of a resin composition. The sample was dried and charged again in the twin screw extruder, together with (C) a phosphorus compound, followed by melt-kneading at a cylinder temperature of 260° C., a screw speed of 130 rpm and an extrusion rate of 12 kg/hour and further charging of a glass fiber from the rear portion of the extruder, which is presumed to undergo melting of the resin, and thus obtaining a pellet-shaped sample of the resin composition.

### Example 5

According to the formulation shown in Table 1, (A) a polybutylene terephthalate resin, (B) a polyvalent hydroxyl group-containing compound, (D) a transesterification catalyst and the above-mentioned antioxidant were charged in a twin screw extruder and then mixed. The mixture was melt-kneaded at a cylinder temperature of 260° C., a screw speed of 130 rpm and an extrusion rate of 10 kg/hour, and then the ejected strand-shaped molten resin was cooled and then cut by a pelletizer to obtain a pellet-shaped sample of a resin composition. The sample was dried and charged again in the twin screw extruder, together with (C) a phosphorus compound, followed by melt-kneading at a cylinder temperature of 260° C., a screw speed of 130 rpm and an extrusion rate of 12 kg/hour and further charging of a glass fiber from the rear portion of the extruder, which is presumed to undergo melting of the resin, and thus obtaining a pellet-shaped sample of the resin composition.

### Comparative Example 1

As shown in Table 2, (A) a polybutylene terephthalate resin and the above-mentioned antioxidant were charged in a twin screw extruder, followed by melt-kneading at a cylinder temperature of 260° C., a screw speed of 130 rpm and an extrusion rate of 12 kg/hour and further a glass fiber was charged from the rear portion of the extruder, which is presumed to undergo melting of the resin, and thus obtaining a pellet-shaped sample of the resin composition. The ejected strand-shaped molten resin was cooled and then cut by a pelletizer to obtain a pellet-shaped sample of a resin composition.

### Comparative Example 2

According to the formulation shown in Table 2, (A) a polybutylene terephthalate resin, (B) a polyvalent hydroxyl group-containing compound and the above-mentioned antioxidant were charged in a twin screw extruder and then mixed. The mixture was melt-kneaded at a cylinder temperature of 260° C., a screw speed of 130 rpm and an extrusion rate of 12 kg/hour. Furthermore, a glass fiber was charged from the rear portion of the extruder, which is presumed to undergo melting of the resin, and the ejected strand-shaped molten resin was cooled and then cut by a pelletizer to obtain a pellet-shaped sample of a resin composition.

### Comparative Example 3

According to the formulation shown in Table 2, (A) a polybutylene terephthalate resin, (B) a compound having a plurality of hydroxyl groups, (C) a phosphorus compound and the above-mentioned antioxidant were charged in a twin screw extruder at the same time, and then mixed. The mixture was melt-knead at a cylinder temperature of 260° C., a screw speed of 130 rpm and an extrusion rate of 12 kg/hour. Furthermore, a glass fiber was charged from the rear portion of the extruder, which is presumed to undergo melting of the resin, and the ejected strand-shaped molten resin was cooled and then cut by a pelletizer to obtain a pellet-shaped sample of a resin composition.

### Comparative Example 4

According to the formulation shown in Table 2, (A) a polybutylene terephthalate resin, (B) a polyvalent hydroxyl group-containing compound, (C) a phosphorus compound, (D) a transesterification catalyst and the above-mentioned antioxidant were charged in a twin screw extruder at the same time, and then mixed. The mixture was melt-knead at a cylinder temperature of 260° C., a screw speed of 130 rpm and an extrusion rate of 12 kg/hour. Furthermore, a glass fiber was charged from the rear portion of the extruder, which is presumed to undergo melting of the resin, and the ejected strand-shaped molten resin was cooled and then cut by a pelletizer to obtain a pellet-shaped sample of a resin composition.

### Evaluation

Using a pellet-shaped sample of a resin composition, a melt viscosity, a tensile strength, a tensile elongation, a flexural strength, a flexural modulus and a melting point shift were measured by the following methods.

### Melt Viscosity

The obtained pellet-shaped sample was dried at 140° C. for 3 hours, and then a melt viscosity was measured at a furnace article temperature of 260° C., a capillary in size of φ1 mm×20 mmL and a shear rate of 1,000 sec⁻¹ in accordance with ISO11443 using CAPILOGRAPH 1B (manufactured by TOYO SEIKI SEISAKU-SHO CO., LTD.). The measurement results are shown in Tables 1 and 2.

### Tensile Strength, Tensile Elongation

The obtained pellets were dried at 140° C. for 3 hours, and then ISO 527-2/1A type tensile test pieces were produced by injection molding under the conditions of a molding temperature of 260° C. and a mold temperature of 80° C. The respective test pieces thus obtained were evaluated in accordance with evaluation criteria defined in ISO 527-1,2. The evaluation results are shown in Tables 1 and 2.

### Flexural Strength, Flexural Modulus

The obtained pellets were dried at 140° C. for 3 hours, and then flexural test pieces were produced by injection molding under the conditions of a molding temperature of 260° C. and a mold temperature of 80° C. and evaluated in accordance with evaluation criteria defined in ISO178. The evaluation results are shown in Tables 1 and 2.

### Melting Point Shift

Measurements were made of an endothermic peak temperature of the obtained pellets observed when measuring under temperature rising conditions ranging from 50° C. to 280° C. at 10° C./minute using DSC Q-1,000 (manufactured by PerkinElmer Co., Ltd.) (hereinafter abbreviated to Tₘ₁); an endothermic peak temperature observed when measuring again under temperature rising rate at 10° C./minute, after maintaining at 280° C. for 5 minutes and cooling to 50° C. under temperature falling conditions at −10° C./minute (hereinafter abbreviated to Tₘ₂); and an endothermic peak temperature observed when repeating a similar treatment (hereinafter abbreviated to Tₘ₃, Tₘ₄). A difference between Tₘ₁ and Tₘ₄ (melting point shift) is shown in Tables 1 and 2.

TABLE 1

| | | Example | | | | | |
|---|---|---|---|---|---|---|---|
| | | 1 | 2 | 3 | 4 | 5 | 6 |
| Polybutylene terephthalate resin (parts by mass) | | 100 | 100 | 100 | 100 | 100 | 100 |
| Partial ester of triglycerol and stearic acid | | 2 | 2 | 2 | 2 | 2 | |
| (parts by mass) | | | | | | | |
| Polyoxyethylene diglyceryl ether | | | | | | | 1 |
| (parts by mass) | | | | | | | |
| Phosphite-based compound (parts by mass) | | 0.2 | 0.2 | 0.2 | | | |
| Monocalcium phosphate (parts by mass) | | | | | 0.1 | 0.1 | 0.1 |
| Tetra-n-butyl titanate (parts by mass) | | 0.01 | | | | 0.01 | |
| Antimony trioxide (parts by mass) | | | 0.01 | | | | |
| Tributyltin acetate (parts by mass) | | | | 0.01 | | | |
| Evaluation | Melt viscosity (Pa · s) | 115 | 112 | 106 | 120 | 105 | 100 |
| | Tensile strength (MPa) | 161 | 152 | 155 | 158 | 154 | 140 |
| | Tensile elongation (%) | 2.6 | 2.4 | 2.5 | 2.5 | 2.5 | 2.2 |
| | Flexural strength (MPa) | 234 | 230 | 232 | 230 | 228 | 210 |
| | Flexural modulus (MPa) | 9200 | 9220 | 9180 | 9210 | 9190 | 8500 |
| | Tm1 (° C.) | 220.8 | 220.1 | 219.7 | 221.1 | 219.5 | 218.6 |
| | Tm4 (° C.) | 220.2 | 219.6 | 219.2 | 220.8 | 219.3 | 218.2 |
| | Melting point shift (° C.) | 0.6 | 0.5 | 0.5 | 0.3 | 0.2 | 0.4 |

TABLE 2

| | | Comparative Example | | | |
|---|---|---|---|---|---|
| | | 1 | 2 | 3 | 4 |
| Polybutylene terephthalate resin (parts by mass) | | 100 | 100 | 100 | 100 |
| Partial ester of triglycerol and stearic acid | | | 2 | 2 | 2 |
| (parts by mass) | | | | | |
| Polyoxyethylene diglyceryl ether | | | | | |
| (parts by mass) | | | | | |
| Phosphite-based compound (parts by mass) | | | | 0.2 | 0.2 |
| Monocalcium phosphate (parts by mass) | | | | | |
| Tetra-n-butyl titanate (parts by mass) | | | | | 0.01 |
| Antimony trioxide (parts by mass) | | | | | |
| Tributyltin acetate (parts by mass) | | | | | |
| Evaluation | Melt viscosity (Pa · s) | 180 | 110 | 160 | 155 |
| | Tensile strength (MPa) | 165 | 160 | 157 | 155 |
| | Tensile elongation (%) | 2.6 | 2.6 | 2.6 | 2.5 |
| | Flexural strength (MPa) | 240 | 235 | 234 | 230 |
| | Flexural modulus (MPa) | 9400 | 9200 | 9100 | 9100 |
| | Tm1 (° C.) | 224.7 | 224.8 | 224.9 | 224.5 |
| | Tm4 (° C.) | 224.6 | 222.1 | 224.6 | 224.1 |
| | Melting point shift (° C.) | 0.1 | 2.7 | 0.3 | 0.4 |

The results of Examples and those of Comparative Example 1 revealed that the present invention makes it possible to reconcile high fluidity when melted and maintaining physical properties such as flexural strength. The results of Examples and those of Comparative Example 2 revealed that the addition of (C) a phosphorus compound terminates transesterification and stabilizes fluidity when melted. The results of Examples and those of Comparative Examples 3 and 4 revealed that the addition of (C) a phosphorus compound on or after melt-kneading of a mixture increases fluidity when melted.

1. A method for producing a polybutylene terephthalate-based resin composition, which comprises melting a mixture containing (A) a polybutylene terephthalate resin and (B) a polyvalent hydroxyl group-containing compound, and then adding (C) a phosphorus compound.

2. The method for producing a polybutylene terephthalate-based resin composition according to claim 1, wherein the polybutylene terephthalate-based resin composition exhibits a value of a melt viscosity of 120 Pa·s or less, measured at a temperature of 260° C. under a shear rate of 1,000 sec⁻¹ in accordance with ISO11443.

3. The method for producing a polybutylene terephthalate-based resin composition according to claim 1 or 2, wherein the polybutylene terephthalate-based resin composition satisfies the following numerical expression (I):
Peak temperature Tₘ₁ (° C.)−peak temperature Tₘ₄ (° C.)≦1 (° C.) (I)
where a peak temperature Tₘ₁ (° C.) in the numerical expression (I) represents a peak temperature of a maximum endothermic peak of a DSC curve in differential scanning calorimetry (DSC) in temperature rising on the 1st cycle when performing 4 cycles, each cycle comprising raising the temperature of the polybutylene terephthalate-based resin composition from 50° C. to 280° C. at a temperature rising rate of 10° C./minute, and dropping the temperature from 280° C. to 50° C. at a temperature falling rate of 10° C./minute, and
a peak temperature Tₘ₄ (° C.) in the numerical expression (I) represents a peak temperature of a maximum endothermic peak of a DSC curve in differential scanning calorimetry (DSC) in temperature rising on the 4th cycle.

4. The method for producing a polybutylene terephthalate-based resin composition according to any one of claims 1 to 3, wherein the mixture further comprises (D) a transesterification catalyst and (D) the transesterification catalyst is added before the addition of (C) the phosphorus compound.

5. The method for producing a polybutylene terephthalate-based resin composition according to any one of claims 1 to 4, wherein (B) the polyvalent hydroxyl group-containing compound is a glycerin fatty acid ester or an ether obtained by an addition reaction of an alkylene oxide to a diglycerin.

6. A polybutylene terephthalate-based resin composition for molding, comprising (A) a polybutylene terephthalate-based resin, (B) a polyvalent hydroxyl group-containing compound, (C) a phosphorus compound and (D) a transesterification catalyst,
wherein a value of melt viscosity, measured at a temperature of 260° C. under a shear rate of 1,000 sec⁻¹ in accordance with ISO11443, is 120 Pa·s or less.
